(19) United States
(12) Patent Application Publication
(10) Pub. No.: US 2004/0196812 A1
(43) Pub. Date: Oct. 7, 2004

(54) Multi-band access point with shared processor

(75) Inventor: Simon Eric Miani Barber, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Instant802 Networks Inc., Brisbane, CA (US)

(21) Appl. No.: 10/409,553

(22) Filed: Apr. 7, 2003

(51) Int. Cl. H04Q 7/00

(52) U.S. Cl. 370/334

(57) ABSTRACT

In a wireless network, an access point supports more than one service with appearance of availability simultaneously to the more than one service, wherein a service relates to supporting a particular protocol, band, channel, etc. An access point might use elements common to more than one service and switch between them often enough that client devices do not conclude that the access point is unavailable each time it is in fact not available for the service expected by the client device. The differing services might be different protocols, bands, channels, etc. The use of the “CTS to self” signal is one method of causing client stations within range to leave a service quiescent for a period so that the access point that sent the signal can activate another service. This signal can also be used for any other need the access point has to cause the medium to be quiescent for a period so that the access point can stop listening and be assured that no necessary signals will be missed, such as avoidance of interchannel interference or a “multiple virtual AP” AP.

### FIELD OF THE INVENTION

The present invention relates to wireless networks in general and multi-protocol or multi-band wireless networks in particular.

### BACKGROUND OF THE INVENTION

Nodes in a wireless network, often referred to as “stations” especially in 802.11 terminology, interact without guarantees that other nodes are available. For example, a laptop computer with a wireless network card installed therein might attempt to communicate with an access point that provides access to a wired network, but the laptop does not necessarily know ahead of time which access points are “visible” (i.e., within range) of the laptop's wireless networking card, and the available access points might change as the laptop moves, the access points move, or interfering elements move into or out of radio paths between the laptop and the access point.

Although other wireless standards, terminology and/or protocols might be used, herein many of the examples will refer to 802.11 networks and protocols and the terminology of 802.11 networks will be used in most examples. Accordingly, a computer or computing device that is mobile or portable (i.e., easily moved, but not likely in motion while in use) and desires to connect to a network through a wireless medium is referred to as a “client station”. A computer, device or circuitry that provides an interface between a wireless medium and a distribution system (“DS”) is referred to as an “access point station” or simply “access point or “AP”. The typical DS is an Ethernet network and although that is used in many examples, it should be understood that the DS might be other than an Ethernet network.

To use a wireless network, a client station will attempt to identify access point stations that are in range of the client station and establish a connection with one of the access points. Periodically, or when the current access point connection fails as the client device goes out of range or interference increases, the client station will scan for other access points and establish a connection with one of the access points, preferably the one with the best signal that is compatible with the client station wireless equipment.

There are a number of 802.11 standards, and other wireless network protocols might have multiple implementations. For example, the 802.11a standard provides for spread-spectrum data transfers in a 5 GHz band, while the 802.11b standard provides for CCK (complementary code keying) signals in a 2.4 GHz band. A client wireless networking card that implements only one standard will seek out access points that support that one standard. For example, an 802.11b wireless networking card in a laptop needs to connect to an access point that supports 802.11b in the wireless channel. Typically, an access point is expected to support multiple connections to client devices in its area.

FIG. 1 illustrates an example wireless network. As shown there, one basic service set (“BSS”) labelled “BSS 1”, provides wireless coverage for the stations labelled STA1, STA2, STA3. In this example, station STA3 is an access point, in that it provides an interface between BSS 1 and a distribution system DS. Other access points are shown: STA4 and STA5. AP STA4 supports BSS 3, and client stations STA7 and STA8 are in range of BSS 2. AP STA5 supports BSS 2. Client station STA6 is in range of BSS 2 as well as STA7, which can “see” two access points.

The interaction between an access point and client devices is illustrated in FIG. 2. As shown there, two or more client devices 200 communicate with an access point 204, which provides client devices 200 with network connectivity to a DS.

FIG. 3 shows a conventional single-band wireless client station in more detail. As shown there, client device 300 comprises a host 302, MAC (media access control) hardware 304, a baseband section 306 and an RF section 308 coupled to an antenna. The host 302 might be part of the client device in the absence of wireless capability (e.g., part of the processing available to a mobile computing device other than that provided by a wireless networking card or module), or host 302 might be part of a wireless networking card or module. Host 302 handles networking above the MAC layer (one of the seven network layers in the ISO/OSI networking standard). MAC hardware 304 can be implemented as hardware, firmware or software executed by a processor, or some combination. In some cases, MAC processing can be, at least in part, implemented as code that is executed external to the MAC hardware 304. Baseband section 306 is typically implemented as digital signal processing hardware, software or a combination, to handle signals at baseband, either as all digital processing or a combination of digital and analog processing. RF section 308 might be implemented as analog circuitry, but might include digital aspects, to interface between the baseband section and the antenna.

In the example of FIG. 3, client device 300 has a single-band client station, and operates on one band, such as 802.11a or 802.11b. FIG. 4 illustrates a client station 400 that can operate on more than one band. As with client station 300, client station 400 has a host 402, MAC hardware 404 and a baseband section 406, but has two RF sections 408(1) and 408(2) and a switch 410 to select between them. In operation, host 402 selects a band and indicates the selection to MAC hardware 404, baseband section 406 and switch 410. Host 402 might periodically, or when an existing signal is lost, scan both bands to find the best reception and then stay on that band.

FIG. 5 shows a variation wherein the RF sections are combined in part, into elements specific to a first band, elements specific to a second band and shared elements. In either case, the effect at the baseband/RF interface is the same: one of the RF bands is the active band and the baseband section interacts with the RF section in conformance with the active band.

An access points might also support multiple bands, as illustrated in FIG. 6. The typical dual-band 802.11 access point that provides service to both 802.11a (and soon 802.11h) stations includes a processor for handling interactions among elements and network communication, along with two sets of MAC hardware, two baseband circuits and two radio circuits. Thus, a dual-band or multi-mode access point might be implemented as two 802.11 stations, one operating in the 5 GHz band providing 802.11a or 802.11h service and another operating in the 2.4 GHz band providing 802.11b and possibly 802.11g service.

Dual-band (and multi-band for more than two bands) access points require more hardware and circuitry than single-band access points and thus are more costly and consume more power. A reduction in the cost and power requirements for a dual-band (or multi-band) access point would make such access points more desirable. Some dual-band access points use shared circuits or processing capability for more than one service, such as an access point that uses elements similar to those shown in FIGS. 4-5, but such access points only maintain connections on the service that is currently active. While that is not a disadvantage where all of the expected client devices are on one band, allowing the access point to remain with that one band, such an access point cannot support client devices in different bands at the same time.

Methods and apparatus that would overcome the above limitations of the prior art would be desirable.

### BRIEF SUMMARY OF THE INVENTION

In a wireless network, an access point supports more than one service with appearance of availability simultaneously to the more than one service, wherein a service relates to supporting a particular protocol, band, channel, etc. In one approach, an access point uses elements common to more than one service and switches between them often enough that client devices do not conclude that the access point is unavailable each time it is in fact not available for the service expected by the client device.

In one approach, the access point operates with one service and signals that other devices should leave the wireless medium open for a period for activity by the access point using protocols of the one service and during that period, the access point instead switches to servicing a different service. The differing services might be different protocols, bands, channels, etc. In another approach, the access point simply switches services and with low utilization of a service, the access point might be able to return to handling that service before a client device assumes that the connection is lost. In some cases, the signal sent by the access point is a “clear-to-send (CTS) to self” signal with a network allocation long enough to cover a sufficient period when the access point is not supporting the service over which the CTS to self was sent, typically a period at least as long as the period when the service is not supported. In yet another embodiment, CFP signals are used to set network allocation vectors (NAV's).

As needed, the access point will switch to a service and transmit a beacon frame to maintain connections between the access point MAC layer and the client device MAC layer. The switching between services could be only to support beacon timing, but more often, the switching might occur several times between each required beacon.

In some instances, the maximum period is about 32 milliseconds (2\hat{ }15 microseconds), but in other implementations, this limitation is overcome. One aspect of embodiments of the invention is that switching occurs frequently enough that stations communicating with the access point using multiple services will each perceive that the access point is active in that service.

The use of the “CTS to self” signal is one method of causing client stations within range to leave a service quiescent for a period so that the access point that sent the signal can activate another service. This signal can also be used for any other need the access point has to cause the medium to be quiescent for a period so that the access point can stop listening and be assured that no necessary signals will be missed. For example, an access point might send a “CTS to self” signal to cause clients to hold off on transmitting in some channels so that the access point can more clearly pick up signals in other channels where interchannel interference from the held-off channels might otherwise degrade the signal in the other channels.

While these techniques can be used for an access point supporting more services simultaneously than the access point can actually service in a dedicated manner, they can also be used to implement related features, such as a “multiple virtual AP” AP.

A further understanding of the nature and the advantages of the inventions disclosed herein may be realized by reference to the remaining portions of the specification and the attached drawings.

### BRIEF DESCRIPTION OF THE DRAWINGS

FIG. 1 is a schematic of a wireless network.

FIG. 2 is a block diagram illustrating wireless communication between an access point and a plurality of client devices.

FIG. 3 is a block diagram of a conventional signal-band client station.

FIG. 4 is a block diagram of a conventional dual-band client station.

FIG. 5 is a block diagram showing an alternative arrangement for elements of the conventional dual-band client station shown in FIG. 4.

FIG. 6 is a block diagram of a conventional dual-band access point station.

FIG. 7 is a block diagram of one embodiment of a dual-band access point station according to aspects of the present invention.

FIG. 8 is a block diagram of an alternative embodiment of a dual-band access point station according to aspects of the present invention.

FIG. 9 is a block diagram illustrating an access point with separate analog sections for distinct protocols and a shared DSP for digital processing of the distinct protocols.

FIG. 10 is a block diagram illustrating an access point with separate analog sections for distinct bands and a shared DSP and intermediate frequency (IF) sections.

FIG. 11 is a timing diagram illustrating processes of switching among services while maintaining connections in those services.

FIG. 12 is a timing diagram illustrating processes of switching among services while maintaining connections in those services, where the services might be standard communications in different channels of a common band.

FIG. 13 is a timing diagram of switching among services illustrating several considerations to be taken into account.

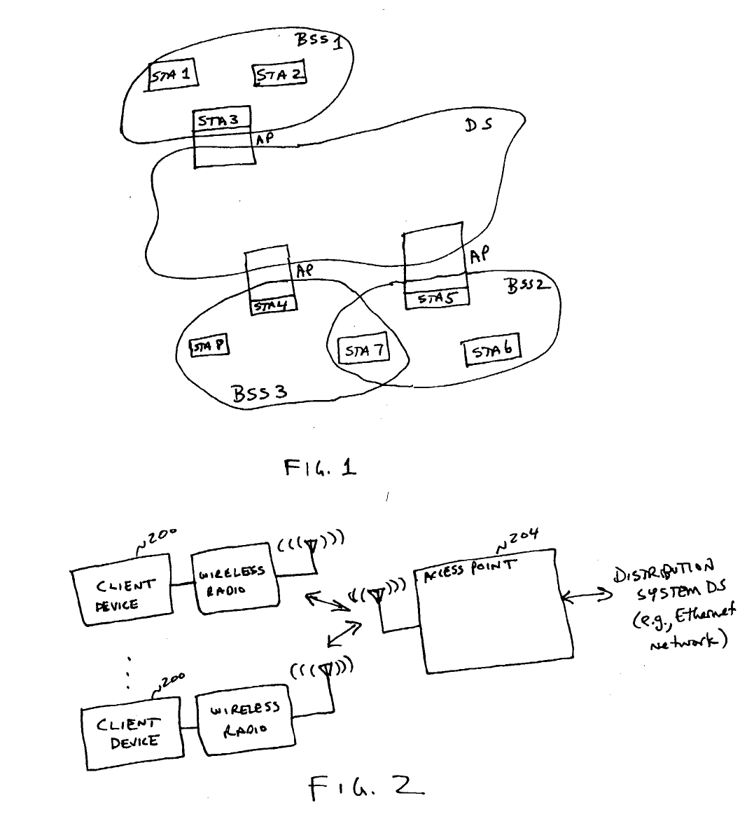

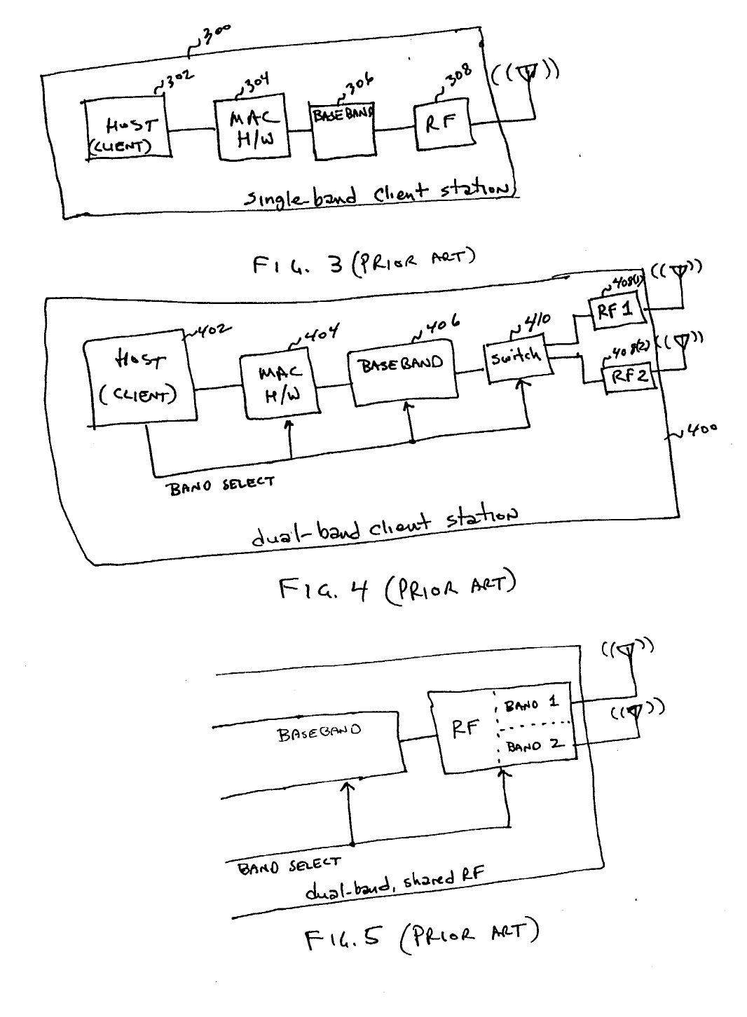

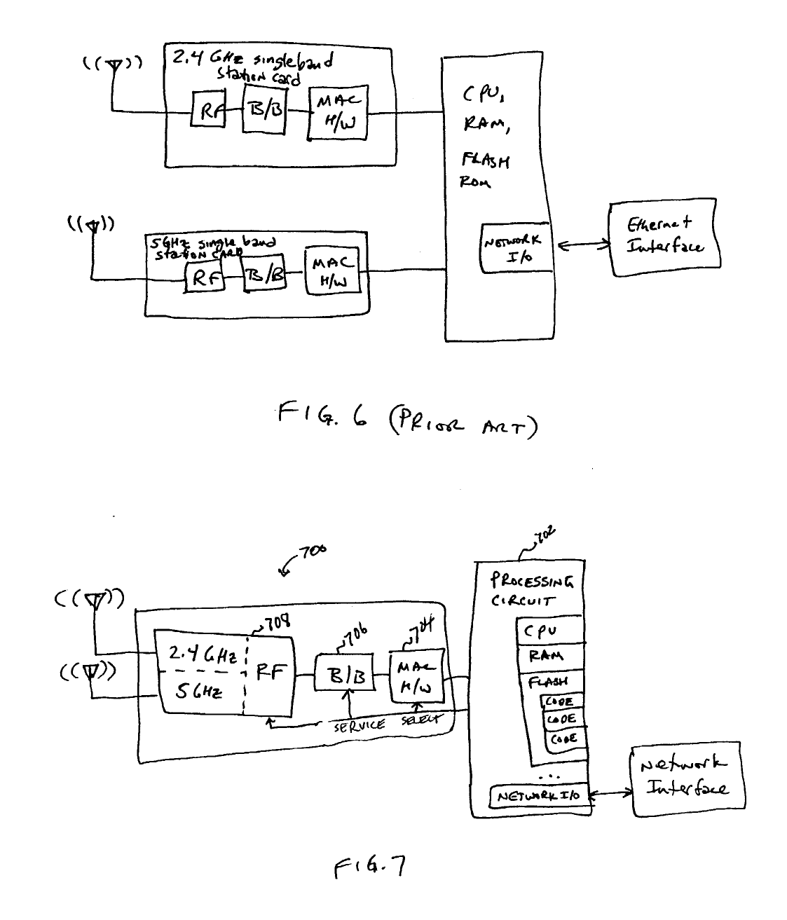

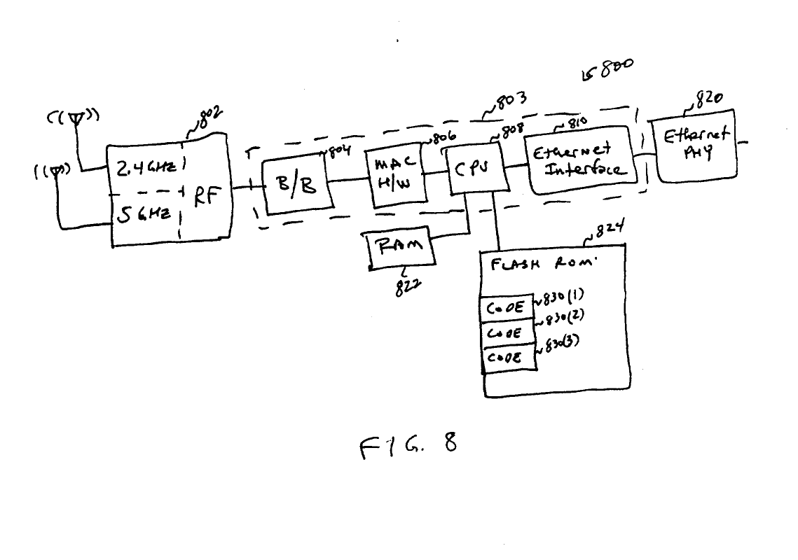

### DETAILED DESCRIPTION OF THE INVENTION

The 802.11 standards (802.11, 802.11a, 802.11b, 8020.11g and others) provide well-known approaches to wireless networking and will not be described in detail here. Instead, they are incorporated by reference as needed, for all purposes. These standards are readily available to one of skill in the art, for example:

801.11: Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications (ISO/IEC 8802-11:1999, ANSI/IEEE Std. 802.11, 1999), LAN/MAN Standards Committee of the IEEE Computer Society, Institute of Electrical and Electronics Engineers (New York, 1999) (available as http://standards.ieee.org/getieee802/download/802.11-1999.pdf at http://standards.ieee.org/getieee802/802.11.html).

801.11a: Supplement to IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications—Amendment 1: High-Speed Physical Layer in the 5 GHz Band (ISO/IEC 8802-11:1999/Amd 1:2000(E), ANSI/IEEE Std 802.11a-1999), LAN/MAN Standards Committee of the IEEE Computer Society, Institute of Electrical and Electronics Engineers (New York, 2000) (available as http://standards.ieee.org/getieee802/download/802.11 a-1999.pdf at http://standards.ieee.org/getieee802/802.11.html).

801.11b: Supplement to IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications: Higher Speed Physical Layer (PHY) in the 2.4 GHz Band (IEEE Std. 802.11b-1999), LAN/MAN Standards Committee of the IEEE Computer Society, Institute of Electrical and Electronics Engineers (New York, 1999) (available as http://standards.ieee.org/getieee802/download/802.11 b-1999.pdf and http://standards.ieee.org/getieee802/download/802.11b-1999_Cor1-2001.pdf at http://standards.ieee.org/getieee802/802.11.html).

801.11g: Draft Supplement to IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications: Standard for Higher Rate (+20 Mbps) Extensions in the 2.4 GHz Band (IEEE Std. 802.11 g draft v. 3.0), Institute of Electrical and Electronics Engineers (New York, 2002).

Using the techniques described herein, an access point (or equivalent network node) can appear to simultaneously support operation for more than one service using a common digital signal processor, by switching between code run for one service and code run for services. The number of services can be two or more, but most examples are with two services. Although the present invention is not limited to particular services, in many examples herein, there are two services and the services are 802.11a wireless communications and 802.11b wireless communications. Thus, it should be understood that distinct “services” might be in distinct bands (such as 2.4 GHz and 5 GHz), but might also be in the same band, such as 802.11b and 802.11g (both in the 2.4 GHz band) or different (preferably nonoverlapping) channels of a multichannel band, such as the 802.11b band.

If the access point needs to ensure that a service is quiescent during a period in which the access point is unable to receive signals for that service, the access point can reserve the medium for itself, even if the access point does not plan to transmit using that service. This “service protection” can be done using a clear-to-send (“CTS”) to self signal (CTS-ts), the 802.11 CFP mechanism (where supported) or other protection technique. Preferably, the period allows time for the access point to switch services (and have radios sync and stabilize as needed) before an open period in which a client device might transmit on the switched-to service and preferably before a beacon frame needs to be sent for the switched-to service.

In some implementations, switching services is entirely dictated by expiration of a CTS-ts period or beacon times, but in others, the switching might also be a function of the relative needs of different services. For example, if the access point notes that one service is busier than another service, the access point could spend more time on the one service. Thus, the proportion of time spent with each service can be varied according to current traffic.

As illustrated in the figures, an access point comprises a digital signal process (DSP) that executes code to effect signal processing according to the service being supported. The DSP handles each different service by running different code for each service (or switching parameters, if the signal patterns are common among services) and preferably stores program data, such as register values, program counters and flags, for each service in a quick storage, to allow the DSP to switch states quickly. In this manner, a station card for an access point can operate multiple services, such as multiple bands, using limited hardware or processing power that can only support less than all of the services being supported, without losing connections in any of the services being supported because the access point was not supporting the service for a short period.

The access point can provide apparent simultaneous service on both a 5 GHz band and a 2.4 GHz band using this approach, which is a significant cost reduction over traditional designs. The aggregate throughput might be limited when compared to the traditional designs, since the access point might be inactive for some time on each band, but this may not be a concern where access point cost is a consideration, such as the small office or home office environment, especially when the time the DSP spends on each band is dynamically arranged according to traffic patterns. Thus a single user on either band will see throughput close to the theoretical maximum, as long as they do not both access both bands simultaneously. The access point might do this by adjusting how much time it spends on each band by calculating an estimate of the offered load on each band, and setting the ratio of the time spent on each band to the ratio of the offered load estimates. The access point preferably always spends a certain minimum amount of time on each band to allow access, even if the offered load estimate on a band is zero.

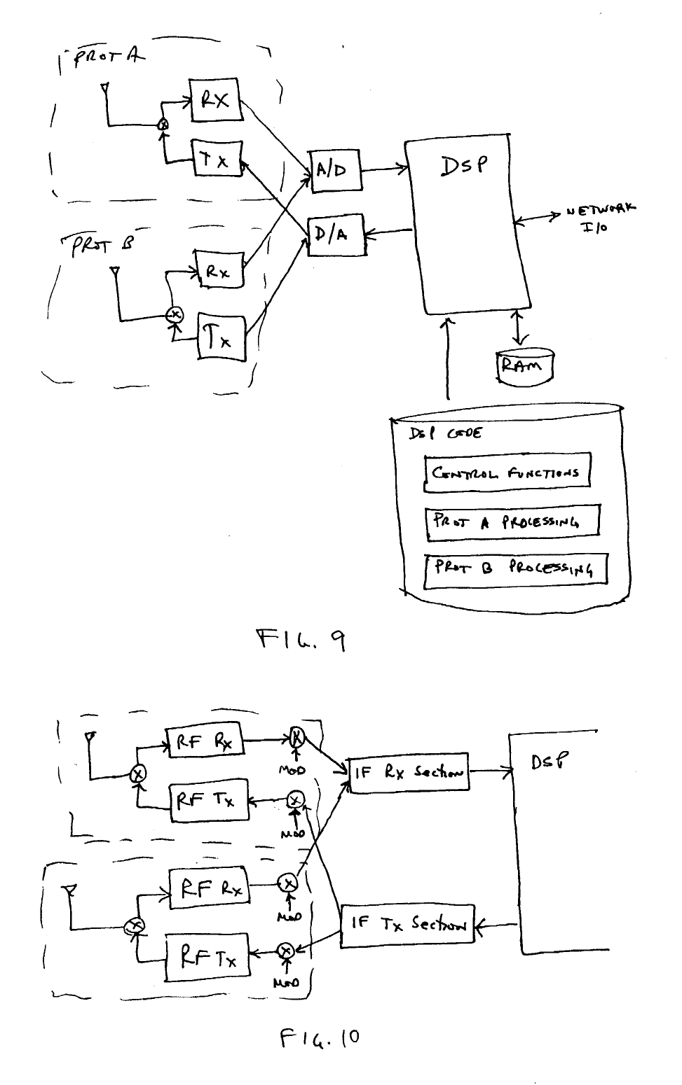

FIG. 7 is a block diagram of one embodiment of a dual-band access point station 700 according to aspects of the present invention. Station 700 is shown comprising a processing circuit 702 (which might be referred to as a “host”), MAC hardware 704, a baseband section 706 and an RF section 708 coupled to antennas that can send RF signals into the wireless medium and receive RF signals from the wireless medium. Processing circuit 702 is shown comprising a CPU, RAM, flash ROM containing various sections of program code executable by the CPU or other processor and network I/O. Other elements might be present, but not shown. For example, MAC hardware 704 might include a processor, but also might rely on another processor such as the CPU of processing circuit 702 to execute MAC code or another processor external to a dual-band station card in the access point.

RF section 708 is shown supporting two bands, but in the general case, it supports N services. RF section 708 might operate to handles interactions with the two antennas and bring received signals down to baseband and bring transmitted signals up to RF, such as over the bands approximately at 2.4 GHz and 5 GHz. Baseband section 706 processes either band, but is preferably simplified enough to handle only one band at a time.

The code executed by processing circuit 702 might be alternatively implemented as hardware, firmware, gate logic, etc. Instead of flash ROM, other storage might be used, such as fixed gate logic, ROM, EEPROM, RAM, etc.

Where program code is used, the program code includes logic to switch various components for various services. Thus, processing circuit 702 might signal to RF section 708 that RF section 708 is to switch from listening/sending on the 2.4 GHz band to listening/sending on the 5 GHz band. Processing circuit 702 might send the “service select” signal at different times to different components, to minimize spurious signals. For example, RF Section 708 might be signaled to not transmit or listen on any band for a guard time, while baseband section 706 and MAC hardware 704 break down one service and set up for another.

The example of FIG. 7 is that the two services supported by the access point are service in one band and service in another band, as might be done with an access point that has to appear to simultaneously support both 802.11a and 802.11b client devices. In a more general example, there are N antennas/RF subsections and the other sections can only handle <N sections at a time, where N is two or more. For example, where N=4, an access point might have four antenna, four RF subsections, and one, two or three sets of baseband/MAC/etc. For simplicity of description, the station is referred to as “dual-band”, but can be generalized to “multi-band” or “multi-service” in one or more frequency band.

FIG. 8 is a block diagram of an alternative embodiment of a dual-band access point station according to aspects of the present invention. In that embodiment, some elements of the access point are implemented on a chip. Specifically, an access point 800 comprises an RF section 802 coupled to antennas and also coupled to a baseband section 804 of a chip 803. Chip 803 is also shown including MAC hardware 806, a CPU 808 and an Ethernet interface 810, which in turn is coupled to an Ethernet PHY layer 820. To simplify chip 803, and possibly to reduce costs, RAM 822 and flash ROM 824 are provided external to chip 803.

CPU 808 is coupled to memory external to chip 803, such as RAM 822 and flash ROM 824, which is shown including several code sections 830.

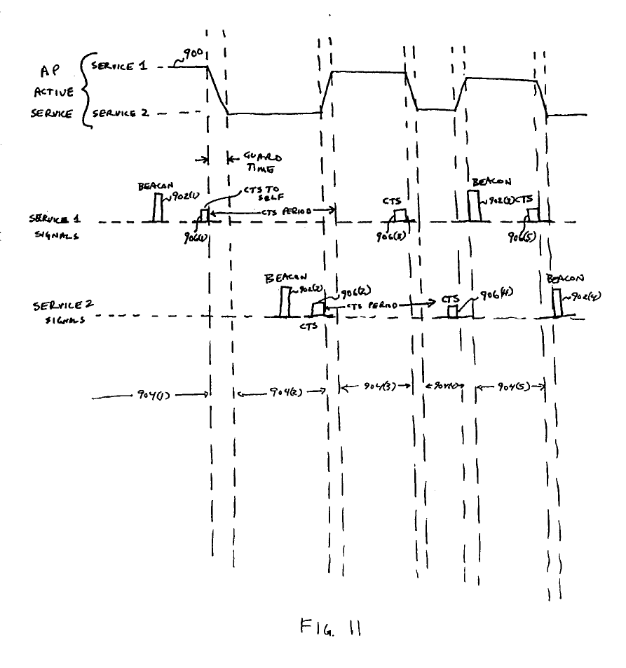

FIG. 9 is a block diagram illustrating an access point with separate analog sections for distinct protocols and a shared DSP for digital processing of the distinct protocols. As shown there, each front end is everything in the analog domain, such that all of the signals in the digital domain are for the active protocol (here, the different services are different protocols, such as 802.11a and 802.11b) and the analog signals are processed for each protocol. Thus, as shown in FIG. 9, when protocol PROT A is active, the A/D and D/A are coupled to the Rx and Tx circuits for that protocol and vice versa when PROT B is active.

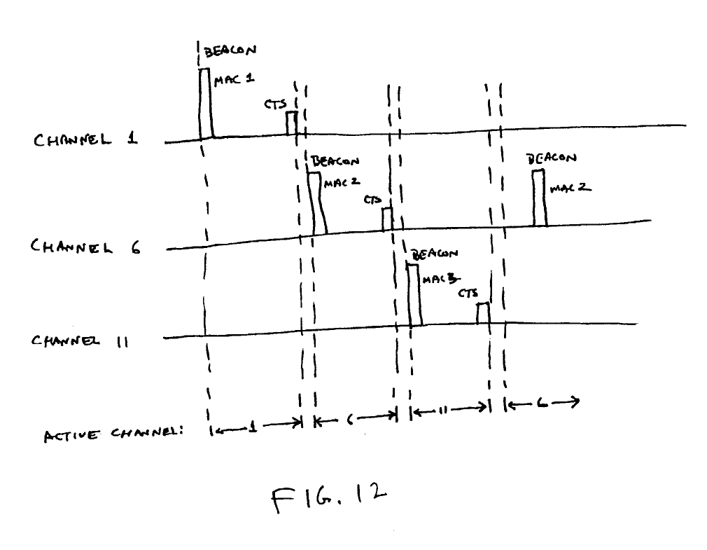

FIG. 10 is a block diagram illustrating an access point with separate analog sections for distinct bands and a shared DSP and intermediate frequency (IF) sections. FIG. 10 shows a variation of what is shown in FIG. 9, wherein only the RF sections are duplicated for each protocol and, following a mixing to and from an intermediate frequency (IF), the Rx section and the Tx section are shared. In other variations, the signals are converted to baseband instead of an intermediate frequency.

Beacons and Protection Mechanisms

The access point transmits beacons at regular intervals referred to here as “beacon periods”. If the beacon period is the same for each service, the access point can stagger the beacons and have a regular pattern of switching among services, such regularity is not required. A suitable beacon period is around 100 ms, but other values will also work. In some implementations, where the CTS-ts protection mechanism is used, the maximum protection time is shorter than the beacon period (e.g., 32 ms vs. 100 ms), so there could be several switches among services without necessarily having a beacon signal during each service period.

FIG. 11 is a timing diagram illustrating processes of switching among services while maintaining connections in those services. There, timing diagram 900 indicates which service is being supported by the access point; the span of time when the access point supports a service continuously is referred to herein as a “switch period”. In this example, there are two services, labeled “Service 1” and “Service 2”, and the access point can support one at a time. In the more general case, there are N services over which connections might be maintained, where N is two or more, and the access point can only support less than N services at one instant but creates the perception that all N services are being supported simultaneously.

With two possible services, the access point switches between them as needed. A guard time is allotted wherein the access point does not support either service for a short period as the access point reconfigures. Thus, there is a switch period for one service, followed by a guard time, then a switch period for the other service, followed by a guard time, etc. Different services might have different guard times, depending on the time needed to set up for a new service, stabilize receiver chains and RF sections, etc.

In the general case, where more than one service is supported at a given instant, when one service is being broken down and another service being set up, the unaffected services might continue through that guard time. Examples of services are 802.11a and 802.11b, or distinct, nonoverlapping 802.11b channels.

Prior to breaking down a service, the access point transmits a CTS-ts signal 906 with a network allocation vector sufficient to cover the time the access point spends supporting the other service, plus the guard times to allow the CTSs to be transmitted (this is a function of the lowest data rate currently in use on that service and the largest possible signal size) and plus the guard times needed to switch to the other service and to switch back. Note that every switch period need not include a beacon signal 902 (as is the case for switch period 904(3) and the beacon signal does not need to be at the start of the switch period, as is the case for beacon signal 902(2). In some cases, however, the access point switches services because it needs to transmit a beacon signal on the “switched-to” service, as in the example of beacon signal 902(3). Note that switch period 904(4) is a short period.

The access point starts on one service, transmitting a beacon signal as needed, and receiving and sending signals, waiting for receiver packets in a conventional manner. At some point, based on one or more considerations, such as the expected traffic on another service, the need to send a beacon on another service, or the expiration of a quiescent period, etc., the access point stops listening with the first service, switches to the second service and performs similar actions with the second service (beacon signalling, listening for packets, transmitting packets, etc.). The access point (AP) should use different local MAC addresses (BSSIDs) on each service, and hence may also use completely different sets of network parameters (SSID, etc) on each service. The use of different SSIDs allows the support of multiple virtual networks on one set of hardware.

A client card will pick up on the beacon signal that is transmitted in a service that the client card operates. For example, if the client card is an 802.11b card, it will pick up on beacons the access point sends using the 802.11b service. If the client card can handle 802.11b and 802.11a, the client card might scan all options and settle on the best one and ignore the others, at least until a polling period expires or the signal degrades. If the client has data ready, it might well be transmitted to the access point before the access point switches over to another service. If any client tries to transmit to the AP while it is operating on the other service, the client will fail and the transmission will be retried. This will eventually succeed, but the large number of failures might cause application problems that need to be addressed.

One approach is to have the switch periods be very short, to increase the chance of retries succeeding before cwMax is reached and the packet is discarded. This might be inefficient in many implementations, because the time it takes to switch (the guard times) might constitute a significant portion of time, decreasing the total useful availability of the medium.

One optimization to this approach is to dynamically adjust how much time is spent on each service, according to an estimate of the load for each service. If one service is idle, then almost all time should be spent on the other service. The time spent on one service (T₁) is set forth in Equation 1, where p₁ is the proportion of time allotted to the first service (p₂=1−p₁), SP is the switch period and GT is the guard time required for the DSP to switch services and be ready to handle traffic on the new service, and the time to guarantee a CTS can be transmitted if this is being done.

T₁=p₁*(SP−2*GT) (Equ. 1)

The proportion p₁ can vary dynamically, can be relatively fixed, or can be hard fixed, such as fixing it to p₁=p₂=0.5. With a dynamic variation, p₁ and p₂ might vary according to a dynamic estimate of the ratio of the load on each band.

A protection mechanism can limit the attempts of another network node to communicate with the access point using a service (e.g., in a band, in a channel, with a protocol, etc.) that is not a current active service for the access point. This helps, especially during high load operation, to avoid client devices detecting apparent failures of the access point.

To keep a client device from transmitting to an access point over a connection that the client believes is active, the access point can signal a reservation of the medium, even though the access point does not plan to use the medium. One method of implementing this is using a “CTS to self” signal to set the NAV (network allocation vector) in multiple stations, an example of which is described in the proposed NAV distribution scheme set forth in Wentink, M., et al., “IEEE P802.11 Wireless LANS: NAV distribution”, IEEE Document No. 802.11/02/332r0 (May 13, 2002), which is incorporated by reference herein for all purposes. Wentink describes the user of CTS to self to protect against interference in the same channel, but here it is used to prevent stations from attempting to access the access point when the access point will be unable to service those stations.

Just before switching to another service, the AP transmits a CTS with the RA address set to the AP's own MAC address for operation on the current service, and the Duration field is set to the amount of time until the AP will be operating on that service again. In the 802.11 standard, the Duration field is currently limited to 32,767 microseconds, so the switch period should be chosen such that T₁+GT and T₂+GT are both less than or equal to that maximum protection time span. The CTS frame will set the NAV in all stations that can hear the AP, and prevent them from transmitting to the AP. The AP sends a similar CTS frame on the second service just before it switches back to the first service, to provide similar protection there. This is illustrated in FIG. 11.

A second method of implementing this is to use CF periods. In this approach, the AP operates with a CF period every beacon. During the CF period, all stations should set their NAVs. By specifying a CF period equal to half the beacon period, the AP can switch to the other band and operate there, knowing that no station on the first band will attempt to access it.

To summarize, the AP can switch services and provide no protection against a client device transmitting over an established connection between the client device and the AP when the AP is not in fact listening. This works acceptably in some low-traffic situations. The AP can implement some protection, such as by setting the network allocation vectors (NAV's) of clients in range of the AP. The NAV's can be set using “CTS to self” signals. While these signals might normally be used by a station to free up the medium for a transmission, here they are used to silence the medium so that the AP can stop listening for a short period and be assured that nothing will be missed while the AP is not listening.

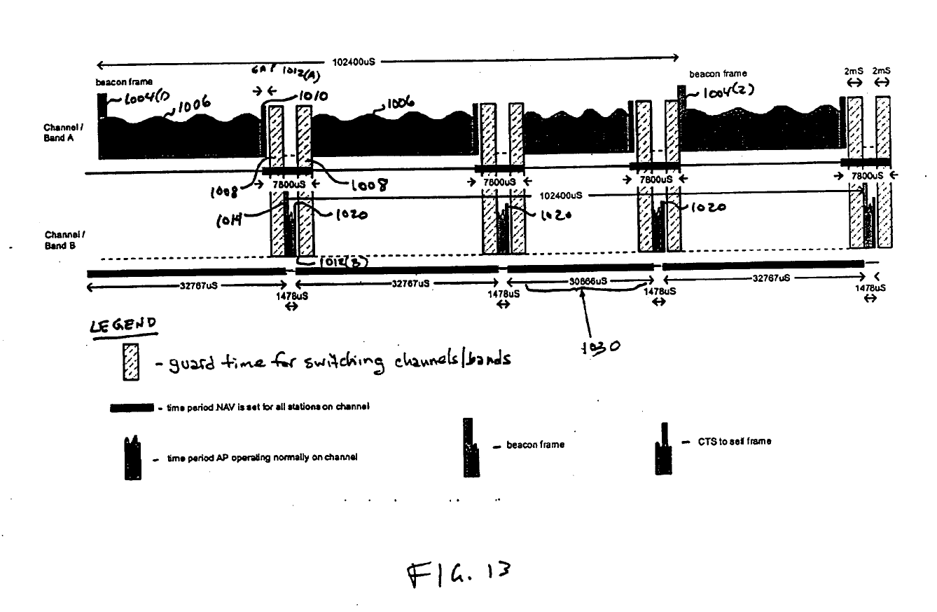

FIG. 12 is a timing diagram illustrating processes of switching among services while maintaining connections in those services, where the services might be standard communications in different channels of a common band. Thus, FIG. 12 shows the variation wherein “dual-band” (or triple-band, etc.) operation is performed in non-overlapping 802.11b channels. As illustrated here, three services are implemented, on 802.11b channels 1, 6 and 11 (which are not overlapping). As shown, the AP sends out a beacon from on channel 1. This beacon frame uses one MAC address, MAC 1. The AP handles packets as needed on channel 1, then sends out a CTS-ts signal to silence client devices until the AP can return to channel 1.

After a guard time, the AP services channel 6. Although the figure shows that the AP does not switch until just before a beacon frame is sent for the switched-to channel, that is not a requirement. When sending a channel 6 beacon frame, the AP uses a different MAC address, MAC 2, in effect operating multiple virtual access points. The AP will then send a CTS-ts signal in channel 6, which should not be picked up by clients listening on channels 1 or 11, as those do not overlap. The AP can then switch to channel 11 and send beacons using yet another MAC address, MAC 3. As illustrated, the AP need not then switch back to channel 1, but can switch to channel 6 instead. However, where the beacon periods are the same for each channel, it might be preferred to switch at regular intervals and in a constant order.

The above-described use of a protection mechanism to allow an access point to service multiple channels (frequency diversity) can be extended to other forms of diversity, such as spatial diversity. In that situation, instead of the access point switching away from one frequency band, it switches away from one direction or location to another. This can be effected by the AP using different antennas or a steerable beamforming antenna to selectively service different spaces by switching RF coverage among antennas or formed beams.

FIG. 13 illustrates some timing considerations. In an example system, beacons are expected each 102400 microseconds (uS) for an active channel. At the start of the timing diagram of FIG. 13, the AP sends a beacon signal 1004 on channel/band A, then operates normally on that band for a period of time, represented as signal 1006. As CTS is used in this example, that period of time is limited such that the AP can switch to channel/band B no later than when its NAV period runs out. In this example, that is 32767 uS. To ensure that the AP can switch in time, the AP begins the switching process early.

Working backwards from the time the AP needs to be on channel/band B, there is a guard time 1008, of 2 mS in this example, for circuit tear-down and set-up. Before that, while the AP is still operating on channel/band A, the AP sends a CTS-to-self signal 1010. Rather than wait until just before the beginning of guard time 1008 when tear-down begins, the AP sends the CTS-to-self signal with a gap 1012. When gap 1012 is taken into account, the CTS-to-self is queue for sending early, since channel access might not be instantaneous. To ensure that the CTS-to-self signal gets to the channel, gap 1012 might be set to the time that the longest data frame would occupy the medium at the lowest data rate currently in use. In this example, gap 1012(A) for channel/band A is 1800 uS and gap 1012(B) for channel/band A is 522 uS.

The CTS-to-self signal in channel/band A in this example sets a NAV time period of 7800 uS, giving a gap of 1800 uS, two guard times of 2000 uS each and 2000 uS dedicated to channel/band B. However, since channel/band B also has a gap 1012(B) of 522 uS, only 1478 uS is available for data transmission. Of course, if more bandwidth is needed, the CTS-to-self in channel/band A can be increased. In that available 1478 uS, the AP transmits a channel/band B beacon 1014, data and a CTS-to-self 1020 in channel/band B before gap 1012(B).

Note that the AP might set shorter switch time periods so that it will be set-up in a channel/band when that channel/band needs a beacon. For example, the AP will send the second CTS-to-self 1020 in channel/band B for a NAV time period 1030 of less than the maximum, 30866 uS in this example, so that the AP can get back to servicing channel/band B and then get to channel/band A by the time a channel/band A beacon is needed.

In some implementations beamforming is used to an advantage to obtain spatial diversity and use that to communicate with different sets of clients. Beamforming AP's typically have a limited number of beams. To try and cover many stations, they can use the CTS to self or CFP to prevent one set of clients talking while the beam is steered to another set.

In an alternative approach, CFP's can be used for a protection mechanism, if the cards that need to support it do support it. Yet other protection mechanisms might be used.

The above techniques and apparatus can also be used to provide multiple virtual access points in a single band. Where the protection mechanism is used, the multiple virtual access points might be on different channels (or one access point might support one virtual access point with one band and another virtual access point with another band). The channels should be sufficiently far apart so that a protection frame transmitted on one channel is not received by stations operating on a second channel (via interchannel cross-over) where a virtual access point is operating. The two virtual access points can have different MAC addresses, and ESSIDs or SSIDs. They can both broadcast their ESSIDs or SSIDs. Since each virtual AP has a different MAC address the different ESSIDs or SSIDs can be distinguished by this, and traffic bridged to and from the virtual APs can be separated in the distribution system. Since the beacon frames include a network name, an access point implementing this can broadcast the presence of different networks, from one access point.

The multiple virtual access points might be used by a wireless provider to support multiple overlapping networks. For example, an airport might install all of the access points in an airport and then provide connectivity to different providers' networks for those providers' customers. Thus, one user might interact with an access point that looks like an access point for that one user's Internet service provider, while another user would interact with that access point and have it look to that second user as an access point that allows access to the second user's Internet service provider but not the network of the first Internet service provider.

Generalization to Other systems

The techniques described herein can be generalized to a system wherein an access point supports client cards distributed over two or more services with an appearance of simultaneously supporting each of the services with a processor or capability that can only support less than all of the two or more services at any one time. Each client device will perceive that there is an access point permanently available, i.e., the client device will not notice, or not react to, the temporary unavailability of the access point for the service between the client device and the access point.

One technique to create this effect is to signal a client card such that it does not try to signal the access point when the access point is not ready to support service with that client card and to switch among the services fast enough that client cards do not designate the temporary unavailability of the access point as a failure of the link to the access point. Thus, the appearance of simultaneous, continuous service is achieved on more bands, protocols, channels, etc. than the access point can actually handle at one time. In a specific embodiment, the access point switches among services it supports by executing different sets of digital signal processing instructions.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A multi-service access point for a wireless network, wherein signal processing is performed at least in part by a programmable digital signal processor, the multi-service access point comprising:
antennas for each of the plurality of services operating over distinct frequency bands;
a signal processor switchable among services;
means for signaling to nodes in the wireless network that use a first service that the signal processor is available for communication using the first service; and
means for switching from communication using the first service to communication using a second service following a signaling that the signal processor is available for communication using the second service.

2. The multi-service access point of claim 1, further comprising means for allocating signal processor time among the services according to traffic load.

3. The multi-service network node of claim 1, further comprising means for signaling, in the second service, a reservation of a medium when the signal processor is to operate according to the first service and for signaling, in the first service, a reservation of a medium when the signal processor is to operate according to the second service.

4. A method of operating an access point to maintain connections with N devices, wherein N is greater than two, with resources that operate simultaneously and instantaneously for less than N services, the method comprising:
signalling availability of the access point according to a first service;
interacting with a network node to establish at least a first connection using the first service;
switching from supporting the first service to supporting the second service;
signalling availability of the access point according to the second service;
interacting with a network node to establish at least a second connection using the second service; and
switching from supporting the second service to supporting the first service, continuing the first connection.

5. The method of claim 4, further comprising signalling, using the first service, a reservation of the medium used for the first service for a reservation period, prior to switching to supporting the second service.

6. The method of claim 5, further comprising switching back to supporting the first service prior to expiration of the reservation period.

7. The method of claim 4, wherein the services comprise a plurality of bands.

8. The method of claim 4, wherein the services comprise a plurality of channels.

9. The method of claim 4, wherein the services comprise a plurality of channels distributed over a plurality of bands.

10. The method of claim 4, wherein the services comprise a plurality of protocols.

11. The method of claim 4, wherein the services include one or more of an 802.11a service, an 802.11b service, an 802.11g service, and an 802.11h service.

12. A method of signalling a wireless medium from a network node that is expected to be responsive to signals from the wireless medium to allow for a period during which the network node will omit otherwise necessary processing to be responsive to the signals from the wireless medium, the method comprising:
signalling a reservation of the wireless medium for a reservation period, thus reserving at least a reserved portion of the wireless medium; and
performing processing other than listening to the wireless medium for signals expected to be received by the network node and other than transmitting in the reserved portion.

13. The method of claim 12, wherein the processing other than listening to the wireless medium is processing signals from a frequency range other than the frequency range within which the reservation was signalled.

14. The method of claim 12, wherein the processing other than listening to the wireless medium is processing signals from a spatial direction other than the spatial directions in which the reservation was signalled.

15. A method of operating an access point in an 802.11 network to maintain connections with N stations, wherein N is greater than two, with resources that operate simultaneously and instantaneously for less than N services, the method comprising:
sending a first service beacon signal from the access point according to a first service;
interacting with at least one of the N stations to establish at least a first connection using the first service;
reserving the medium for the first service for a first network allocation time period;
switching the access point from supporting the first service to supporting a second service;
sending a second service beacon signal from the access point according to the second service;
interacting with at least one of the N stations to establish at least a second connection using the second service; and
before the first network allocation time period expires:
(a) reserving the medium for the second service for a second network allocation time period; and
(b) switching the access point from supporting the second service to supporting the first service,
thereby continuing the first connection.

16. The method of claim 15, wherein the first service is an 802.11a service and the second service is an 802.11b service, wherein at least one of the N stations is not configured to process both 802.11a and 802.11b signals.

17. The method of claim 15, wherein the first service is a service in a first frequency range and the second service is a service in a second frequency range, wherein at least one of the N stations is not configured to process signals in both frequency ranges.

18. The method of claim 15, wherein the first service is a service in a first spatial range and the second service is a service in a second spatial range, wherein at least one of the N stations is not configured to process signals in both spatial ranges.

19. The method of claim 15, wherein reserving the medium for a given service comprises sending a clear to send (CTS)-to-self signal using that given service and indicating a time period commensurate with the network allocation time period.

20. The method of claim 15, wherein reserving the medium for a given service comprises queuing a sending a clear to send (CTS)-to-self signal using that given service and indicating a time period commensurate with the network allocation time period, wherein the queuing is scheduled in advanced such that the medium will be guaranteed available soon enough to allow for transmission of the CTS-to-self signal using the given service and switching to subsequent service prior to expiration of a reserved network allocation time period for the subsequent service.

21. The method of claim 20, wherein a guarantee of transmission of the CTS-to-self signal and switching prior to expiration of the reserved network allocation time period is effected by a step of queuing the CTS-to-self signal in advance of a time gap determined by the transmission time of a longest data frame at a lowest data rate.
